(19) United States
(12) Patent Application Publication
(10) Pub. No.: US 2024/0135286 A1
(43) Pub. Date: Apr. 25, 2024

(54) SECURITY ECOSYSTEM, DEVICE, SYSTEM AND METHOD FOR MITIGATING CONFLICTS IN WORKFLOWS

(71) Applicant: MOTOROLA SOLUTIONS, INC., Chicago, IL (US)

(72) Inventors: Pawel JURZAK, Krakow (PL); Pawel WILKOSZ, Krakow (PL)

(21) Appl. No.: 17/969,081

(22) Filed: Oct. 18, 2022

(51) Int. Cl. G06Q 10/06

(52) U.S. Cl. CPC G06Q 10/0633

(57) ABSTRACT

A security ecosystem, device, system and method for mitigating conflicts in workflows is provided. A computing device is provided having a network interface and a processor configured to receive workflows from a plurality of workflow computer systems and identify conflicts in the one or more physical devices that are shared among the workflows. The processor mitigates identified conflicts by modifying at least one of the workflows to avoid an identified conflict and provides the modified workflow back to one or more of workflow computer systems implementing the workflows that caused the conflicts.

### BACKGROUND OF THE INVENTION

Managing multiple devices within a security ecosystem may be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a security ecosystem capable of configuring and automating workflows, in accordance with some examples.

FIG. 2 depicts a security ecosystem capable of configuring and automating workflows, in accordance with some examples.

FIG. 3 depicts a security ecosystem capable of configuring and automating workflows, in accordance with some examples.

FIG. 4 depicts a security ecosystem capable of configuring and automating workflows, in accordance with some examples.

FIG. 5 depicts a security ecosystem capable of configuring and automating workflows, in accordance with some examples.

FIG. 6 is a block diagram of a workflow server of FIG. 1, in accordance with some examples.

FIG. 7 is a block diagram of a workstation of FIG. 1 utilized to generate a workflow, in accordance with some examples.

FIG. 8 depicts a dashboard for generating a workflow, in accordance with some examples.

FIG. 9 depicts the dashboard of FIG. 8 with an example workflow, in accordance with some examples.

FIG. 10 depicts the dashboard of FIG. 8 with other example workflows, in accordance with some examples.

FIG. 11 depicts a security ecosystem similar to FIG. 1, but instead operating on a plurality of servers receiving workflow instructions from a plurality of workstations operated by different agencies.

FIG. 12 depicts the dashboard of FIG. 8 with a first example of two conflicting workflows, with one workflow having a higher priority than the other.

FIG. 13 depicts the dashboard of FIG. 8 with a first example of two conflicting workflows, with one workflow having a higher priority than the other.

FIG. 14 depicts the dashboard of FIG. 8 with a first example of two conflicting workflows, with one workflow having a higher priority than the other.

FIG. 15 depicts an exemplary flowchart of an optional method of operating the present security ecosystem.

FIG. 16 depicts the dashboard of FIG. 8 showing a lower priority workflow being modified when it conflicts with a higher priority workflow.

FIG. 17 depicts the dashboard of FIG. 8 showing an additional device being activated to assist a first device in the event of a workflow conflict.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing workflows across multiple differing systems and devices is provided herein. During operation, a computing device, such as a workflow server, may monitor one or more triggers that occur in the differing systems and devices based on sensor data generated by, and received from one or more sensors, and, in response, implement one or more actions that may include communicating with one or more communication devices across the differing systems and devices, for example to dispatch security personnel associated with the one or more communication devices to locations, at which the sensor data was collected that lead to the triggers. However, it may be challenging to communicate to the one or more communication devices the sensor data that lead to the one or more triggers and/or to change and/or control the safety workflows. Thus, there exists a need for an improved technical system, device, and system for communicating with communication devices based on workflow interactions.

Hence, provided herein is a computing device, for example in the form a workflow server interacting with a workstation, which monitors execution of a safety workflow and/or a plurality of safety workflows. A safety workflow is understood to include an association between a trigger, which occurs when certain conditions are met as determined using sensor data from a physical sensor, and an action, which occurs in response to the trigger, and which may include at least an electronic interaction and/or communication with a communication device. One example trigger may comprise determining that a given door is open (e.g. and/or has been open for a given time period) and a responsive action may comprise communicating with a given communication device to dispatch security personnel operating the communication device to the location of the open door.

The present system provides a computing system having a network interface and a processor and method of using same where the processor is specifically configured to resolve workflow conflict among shared physical devices (including but not limited to all manner of IoT devices such as cameras, locks, occupancy sensors, bio-sensors, drones, etc.) In operation, the present system receives workflows from a plurality of different workflow computer systems and identifies conflicts between or among one or more of these physical devices. The present system and method mitigates the identified conflicts by modifying at least one of the workflows to avoid the identified conflict. In addition, the present system provides the modified workflow back to one or more of workflow computer systems implementing the workflows that caused the conflict(s). In optional aspects, modifications to avoid conflicts may include reorganizing workflow steps, generating alternate workflow steps or activating additional physical devices to perform assigned workflow steps (or some combination thereof). In addition, one workflow may be prioritized over another, and such prioritization may be done in accordance with established public safety parameters (for example, the police may be given priority access to a school camera over school administrators). Optionally, systems may be included for changing or adding workflow triggers or actions to mitigate the identified conflict(s). Optionally as well, historic workflow data may be analyzed by an analytical engine to predict conflict between or among the various physical devices.

In one optional aspect, the present system provides a computing device comprising a network interface and a processor where the processor is configured to: receive workflows from a plurality of workflow computer systems, the workflows comprising: respective triggers and respective responsive actions that are executed by one or more physical devices; identify conflicts in the one or more physical devices that are shared among the workflows received from the plurality of workflow computer systems; modify at least one workflow to avoid an identified conflict; and provide the at least one workflow as modified back to one or more of workflow computer systems implementing the workflows that caused the conflicts.

In optional aspects, two workflow computer systems are involved and the present system sends the workflow as modified back to both workflow computer systems.

In optional aspects, the processor is further configured to modify the at least one workflow by one or more of: reorganizing workflow steps; generating alternative workflow steps; and activating additional physical devices and assigning one more of existing workflow actions and the alternative workflow actions to the additional physical devices. Workflows may be modified in various ways, including but not limited to: changing one or more triggers of one or more of the workflows; adding one or more alternative triggers to the one or more of the workflows; changing one or more actions of one or more of the workflows; and adding one or more alternative action to the one or more of the workflows.

In optional aspects, the processor is further configured to modify at least one workflow to avoid the identified conflict by prioritizing a first workflow received from a first workflow computer system over a second workflow received from a second workflow computer system. The processor may execute the first workflow and not the second workflow or execute the first workflow and modify the second workflow to avoid or mitigate the conflict.

In optional aspects, historic workflow execution data is logged and the processor is further configured to predict conflicts among the physical devices by analyzing the historic workflow execution data.

In addition, the present system includes an optional method of managing workflows received from a plurality of workflow computer systems, comprising: receiving, in a multi-workflow computing device, workflows from a plurality of workflow computer systems; identifying, in the multi-workflow computing device, conflicts in IoT devices that are shared among the workflows; mitigating, in the multi-workflow computing device, the conflicts among the IoT devices by modifying at least one workflow to avoid a conflict; and providing the at least one workflow as modified back to one or more of workflow computer systems implementing the workflows that caused the conflicts.

Each of the above-mentioned aspects will be discussed in more detail below, starting with example system and device architectures of the system in which the embodiments may be practiced, followed by an illustration of processing blocks for achieving an improved security ecosystem and/or an improved Security Ecosystem, Device, System and Method For Mitigating Conflicts In Workflows.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that may direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification may be implemented or combined with any part of any other aspect or embodiment discussed in this specification.

Further advantages and features consistent with this disclosure will be set forth in the following detailed description, with reference to the drawings.

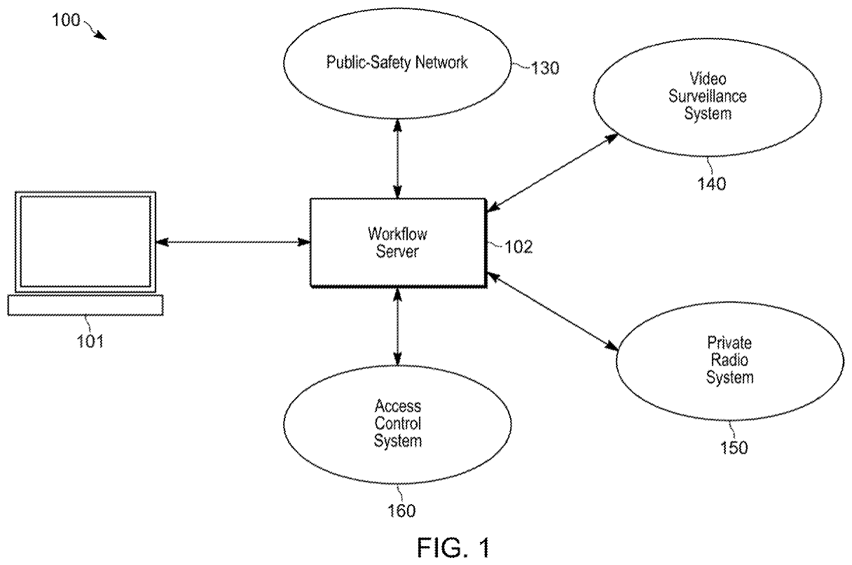

Turning now to the drawings, wherein like numerals designate like components, FIG. 1 illustrates a security ecosystem 100 capable of configuring and automating workflows across multiple systems. The security ecosystem 100 is interchangeably referred to hereafter as the system 100. Furthermore, workflows as referred to herein may alternatively be referred as security workflows or workflows that may be used to implement security-based action and/or security based processes.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private radio system 150, and an access control system 160. A workflow server 102 is coupled to each system 130, 140, 150, and 160. The workstation 101 is shown coupled to the workflow server 102 and is utilized to configure the workflow server 102 with workflows, for example as generated by a user. It should be noted that although the components in FIG. 1 are shown geographically separated, these components may exist within a same geographic area, such as, but not limited to a school, a hospital, an airport, a sporting event, a stadium, a factory, a warehouse and/or any other suitable location and/or building and the like. It should also be noted that although only networks and systems 130, 140, 150, 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution™'s Orchestrate™ and/or Ally™ dispatch and incident management software. As will be discussed in more detail below, the workstation 101 is configured to present a user with a plurality of triggers capable of being detected by the network and systems 130, 140, 150, 160 as well as present the user with a plurality of actions capable of being executed by the network and systems 130, 140, 150, 160. The user will be able to generate workflows and upload these workflows to the workflow server 102 based on the presented triggers and actions. While only one workstation 101 is shown, the system 100 may comprise a plurality of workstations 101.

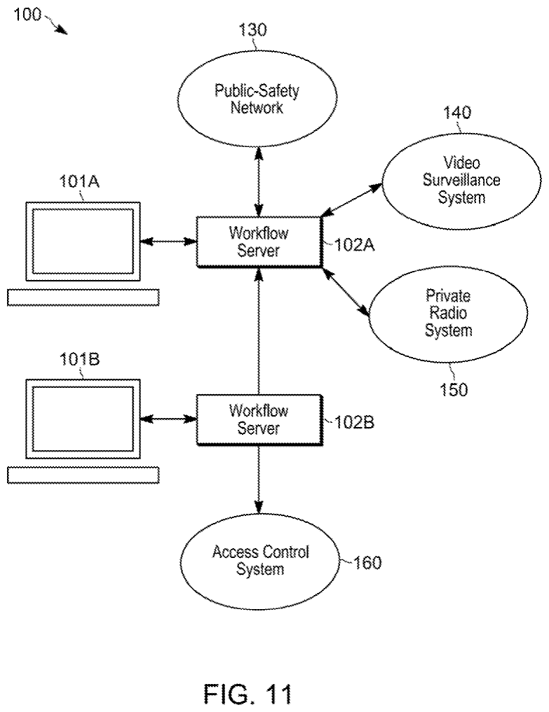

The workflow server 102 may comprise a server running Motorola Solution™'s Command Central™ software suite comprising the Orchestrate™ platform. While the workflow server 102 is depicted as one device, the workflow server 102 may be implemented as one or more computing devices (e.g.: as seen in FIG. 11), one or more servers (as also seen in FIG. 11), one or more cloud computing devices, and the like, and/or the functionality of the workflow server 102 may be geographically distributed.

The workflow server 102 is configured to receive workflows generated by the workstation 101 (and/or a plurality of workstations 101A and 101B in FIG. 11) and implement the workflows. Furthermore, the workflow server 102 may implement (e.g., concurrently, and the like) different workflows associated with different workstations. Particularly, the workflows are implemented by analyzing events detected by the network and systems 130, 140, 150, 160 and executing appropriate triggers. In a particular example, a user may generate a workflow on the workstation 101 that has a trigger comprising the video surveillance system 140 detecting a loitering event, and has an action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field-of-views over time. The video surveillance system 140 is configured with a recognition engine/video analysis engine (VAE) that comprises a software engine that analyzes any video captured by the cameras using, for example, any suitable process, which may include, but is not limited to machine learning algorithms, convolutional neural networks (CNNs), and the like. Using the VAE, the video surveillance system 140 is capable of “watching” video to detect any triggers and report the detected triggers to the workflow server 102. These triggers may include, but are not limited to, appearance searches and unusual Activity Detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution™'s Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IoT) network, which may serve to connect every-day devices to the Internet. Devices such as cars, kitchen appliances, medical devices, sensors, doors, windows, HVAC (heating, ventilation, and air conditioning) systems, drones, . . . , etc. may all be connected through the IoT network of the access control system 160. Indeed, any suitable device that may be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to generate rule-based, automated workflows between technologies to enhance efficiency, and improve response times, effectiveness, and overall safety. The security ecosystem 100 generally has the capability to detect triggers across a number of devices within network and systems 130, 140, 150, 160 and quickly take actions by automatically executing the proper procedure (i.e., executing the appropriate action once a trigger is detected).

The network and systems 130, 140, 150, 160 are next described in further detail.

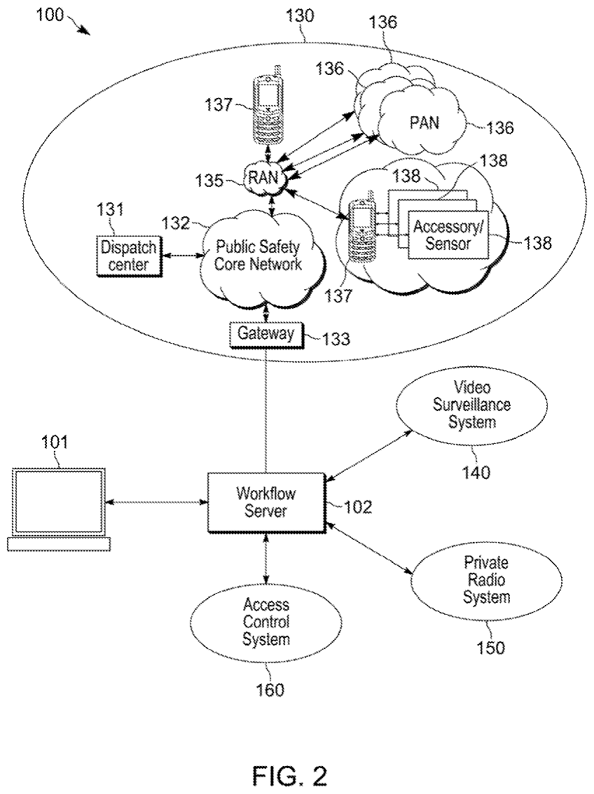

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least one radio 137, such as a public-safety radio and the like (however the radios 137 may include, but are not limited to, any suitable combination of communication devices, such as mobile phones, two-way radios, and the like). As shown, each PAN 136 comprises a radio 137 acting as a hub to smart devices/accessories/sensor 138 (interchangeably referred to hereafter as the sensors and/or a sensor 138). Hereafter the radios 137 may be interchangeably referred to as a communication device 137.

The gateway 133 may comprise an Avigilon™ Control Center running Avigilon's Access Control Management software. The gateway 133 is configured to run any suitable Application Program Interface (API) to provide communications between the public-safety core network 132 and the workflow server 102.

A public safety officer (not shown in FIG. 2) may be equipped with sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g. in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control, over which accessories are allowed to connect to each other when forming a PAN 136. Once bonded, accessories may establish a connection without user intervention. A bond may be generated through a process called “pairing”. The pairing process may be triggered by a specific request by the user to generate a bond from a user via a user interface on the accessories. Thus, as shown, public-safety network 130 incorporates PANs 136 generated as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VoIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and provide some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensor 138 via a local communication link. The radios 137 may be configured to determine when to forward information received from PA sensors 138 to, for example, a dispatch center or the workflow server 102.

Some examples of sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137, which may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction, in which a person or device is facing. This information may be reported to a radio 137, which may forward the information to dispatch center 131 and/or the workflow server 102.

In some examples, a sensor 138 may comprise a heart rate sensor that uses electrical contacts with the skin to monitor an electrocardiography (EKG) signal of its wearer, or may use infrared light and imaging device to optically detect a pulse rate of its wearer, among other possibilities. This information may be reported to a radio 137, which may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137, which may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public-safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

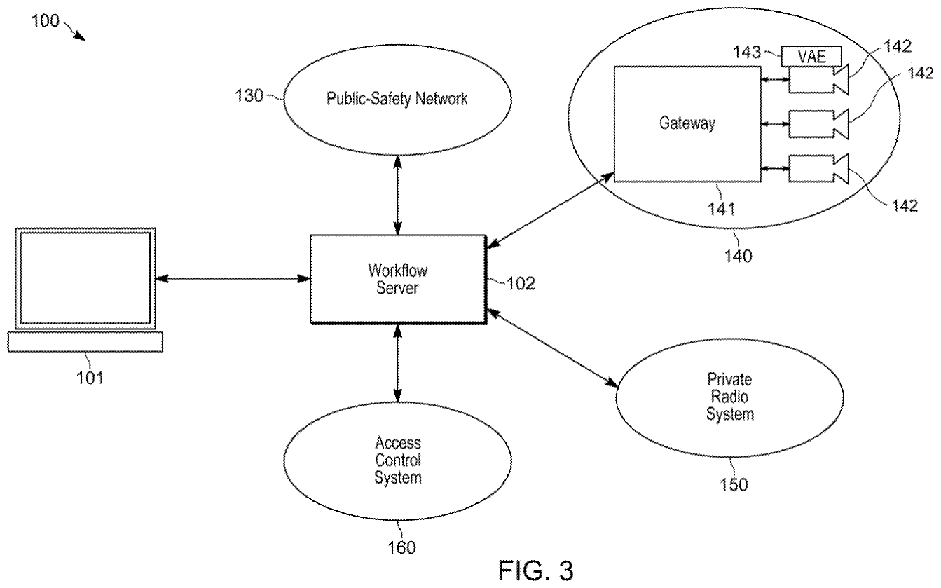

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of image sensors and/or cameras 142 and the gateway 141.

Cameras 142 may be fixed or mobile and may have pan/tilt/zoom (PTZ) capabilities to change their field-of-view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The VAE 143 is generally configured to “watch” video and detect pre-selected objects such as license plates, people, faces, automobiles. The VAE 143 may also be configured to detect certain actions of individuals, such as fighting, loitering, crimes being committed, . . . , etc. and/or actions of objects, such as speeding, a car driving on a pedestrian walkway, a car moving against the flow of traffic, . . . , etc.; however the VAE 143 may be configured to detect any suitable action. The VAE 143 may contain any of several object/action detectors. Each object/action detector “watches” the video for a particular type of object or action. Object and action detectors may be mixed and matched depending upon what is trying to be detected. For example, an automobile object detector may be utilized to detect automobiles, while a fire detector may be utilized to detect fires. Combinations of object detectors may be utilized to detect combinations of objects, such as automobiles on fire, and the like, automobiles that are not on fire, and the like.

The gateway 141 may comprise an Avigilon™ Control Center running Avigilon's Access Control Management software. The gateway 141 is configured to run any suitable Application Program Interface (API) to provide communications between any cameras 142 and the workflow server 102.

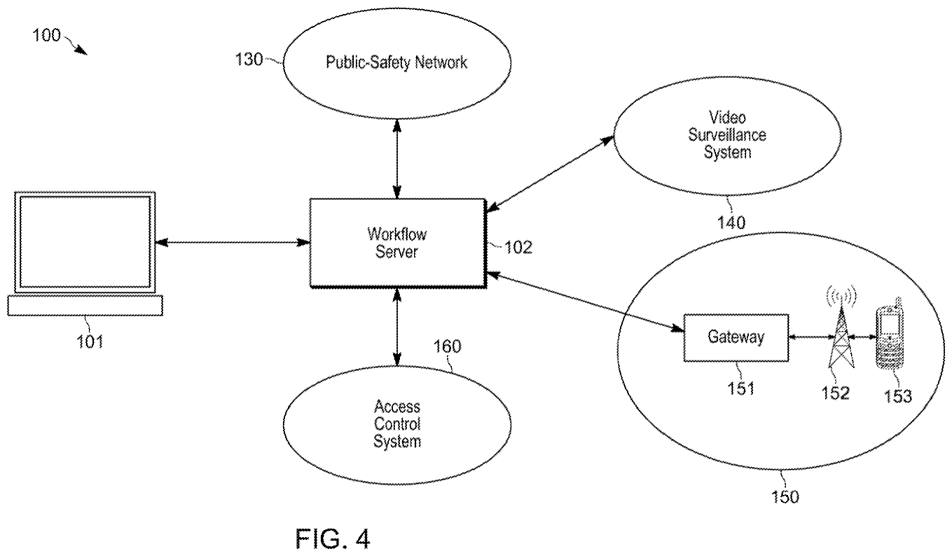

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one radio 153. Communications from the radio 153 to the workflow server 102 passes through the system infrastructure 152, the gateway 151, and ultimately to the workflow server 102. Hereafter the radios 153 may be interchangeably referred to as a communication device 153.

The gateway 151 may comprise an Avigilon™ Control Center running Avigilon's Access Control Management software. The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solution™'s MOTOTRBO™ equipment, such as an SLR Series Repeater (e.g., SLR 1000, SLR 5000, or SLR8000 repeater) configured to provide two-way radio service to radio 153.

Although only a single radio 153 is shown in FIG. 4, any suitable number of radios 153 may be present within the private radio system 150. Each radio 153 may comprise a MOTOTRBO™ two-way radio (such as a Motorola Solution™ XPR 5000 Series radio) with digital technology providing integrated voice and data communication.

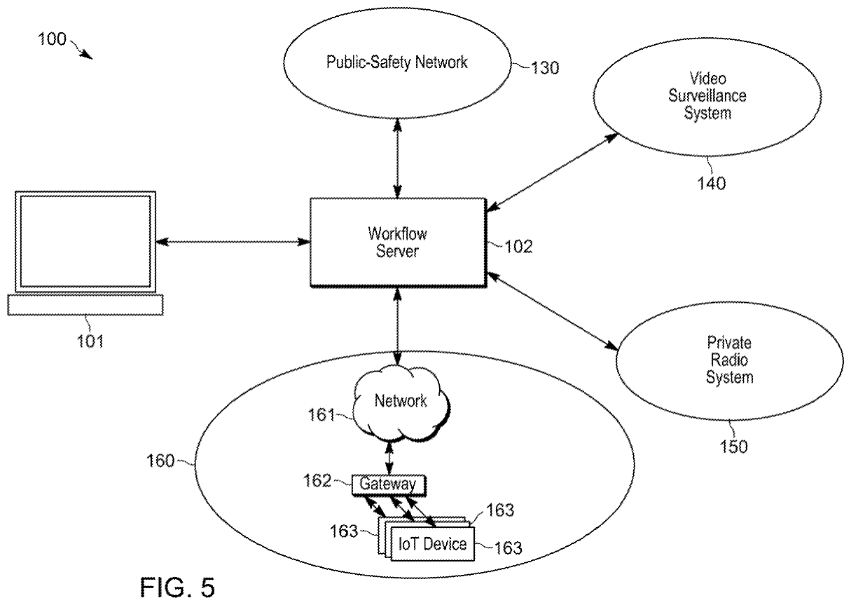

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise devices that control objects, doors, windows, sensors, and the like. Any particular suitable communication protocol (e.g. an IoT protocol) may be used for each IoT device. For example, various proprietary protocols such as DNP, Various IEC**** protocols (IEC 61850 etc. . . . ), bacnet, EtherCat, CANOpen, Modbus/Modbus TCP, EtherNet/IP, PROFIBUS, PROFINET, DeviceNet, . . . , etc. may be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PoIP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

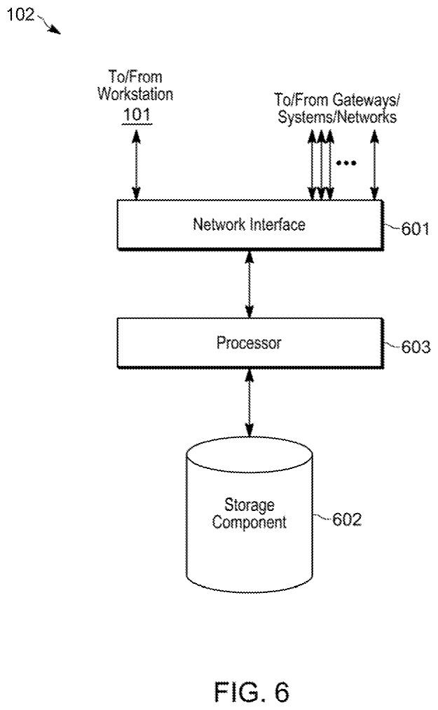

FIG. 6 is a block diagram of the workflow server 102 of FIG. 1. As shown, the workflow server 102 comprises a network interface 601, a storage component 602 (e.g. as depicted a database, but may comprise any suitable memory and/or storage component), and a processor 603. The processor 603 is understood to include any suitable logic circuitry.

The network interface 601 includes any suitable components for communicating with other suitable components of the system 100, in particular, as depicted, to the workstation 101, the gateways 133, 141, 151, 162 of the networks and systems 130, 140, 150, 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces, T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g. of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may execute an instruction set/software (e.g., Motorola Solution™'s Command Central™ software suite comprising the Orchestrate™ platform), which may be stored at the storage component 602.

The storage component 602 may comprise standard memory (such as Random Access Memory (RAM), Read Only Memory (ROM), and the like) and generally serves to store associations between triggers and actions. Examples of various triggers and actions are illustrated in in Table 1, below.

TABLE 1
Associations Between Triggers and Actions.

| Trigger | Action |
|---|---|
| Warehouse back door opened | Pan camera “342” to point at door |
| Man-Down sensor activated | Notify dispatch center via emergency text |
| for Officer Smith | message |
| ALPR for delivery truck | Open back gate |
| . . . etc. | . . . etc. |

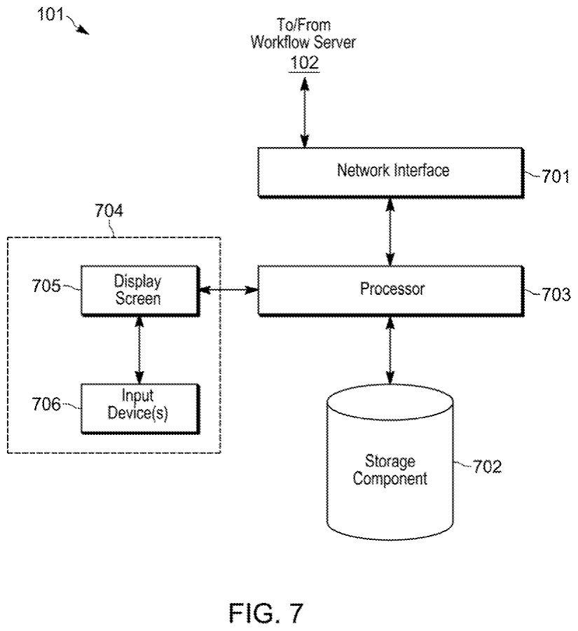

FIG. 7 is a block diagram of the workstation 101 of FIG. 1 utilized to generate a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution™'s Orchestrate™ and Ally™ dispatch and incident management software, which may be stored at the storage component 702. The execution of such software may allow users of the GUI 704 to generate workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution™'s Orchestrate™ and Ally™ dispatch and incident management software may be stored at the storage component 702.

The GUI 704 generally provides a man/machine interface for receiving an input from a user and displaying information. For example, the GUI 704 may provide a mechanism of conveying (e.g., displaying) user-generated workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g. a keyboard and mouse combination).

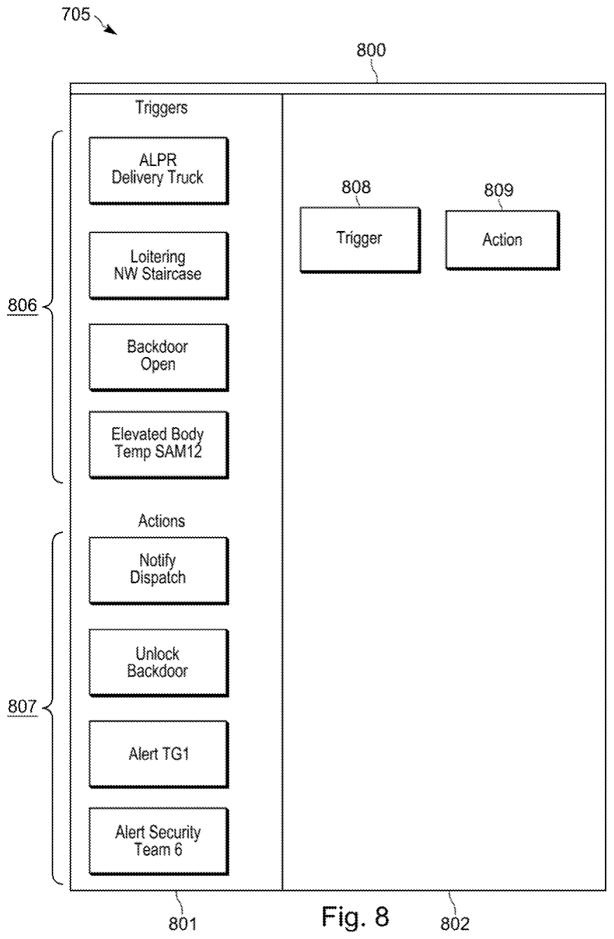

FIG. 8 illustrates the generation of a workflow. More particularly, FIG. 8 illustrates a dashboard 800 rendered at the display screen 705 utilized for the generation of workflows. As depicted, the dashboard 800 consists of the following main components:
a selection panel 801 (e.g. on a left-hand side), which lists available triggers 806 and actions 807;
a workspace 802, which comprises a large area in the middle of the dashboard 800 used to generate workflows that define the connections between triggers and actions. Each workflow in the workspace is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable various sensors, software, and devices within the security ecosystem 100, including, but not limited to, the radios 137, 153.

After a workflow is deployed (i.e., uploaded to the workflow server 102), its actions activate when the triggers occur. Triggers and actions appear on the workspace after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace (as described below) will generate a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow generation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as a trigger node, and an action 807 may be referred to as an action node. In order to associate the trigger 806 with the action 807, they are connected. To connect a trigger node to an action node, a user may click an end of the trigger node (e.g. that is closest to the action node) and drag a line to the action node, or vice versa. However, any suitable process for connecting nodes is within the scope of the present specification.

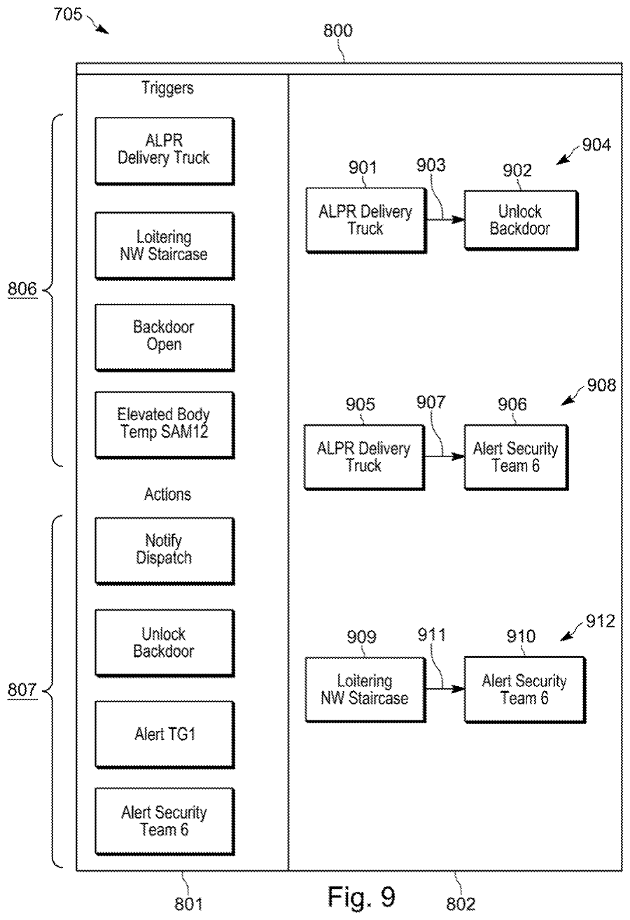

As shown in FIG. 9, which depicts the dashboard 800 in use, a trigger “ALPR Delivery Truck” 901 has been associated with an action “Unlock Backdoor” 902 by dragging a line 903 between the two, thereby forming a workflow 904. While only one trigger 901 and one action 902 is depicted in the workflow 904, the workflow 904 may comprise any suitable number of triggers (e.g. a trigger group) and any suitable numbers of associated action (e.g. an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g. the trigger 901), an associated backdoor (e.g. of a warehouse) is opened; such a backdoor may also comprise one of the IoT devices 163. While note depicted, a memory in the system 100 may also store a list of license plates. for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate readers, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger 806 for detecting loitering at a particular “North West” (e.g. NW) staircase of a particular building (e.g. “Loitering NW Staircase”) that may be detected using a VAE 143 of one or more cameras 142 and the like. The triggers 806 further includes a trigger 806 for detecting whether a particular backdoor is open (e.g. “Backdoor Open”) that may be detected using a VAE 143 of one or more cameras 142 and/or an open/closed sensor on the backdoor and the like. The triggers 806 further includes a trigger 806 for detecting whether a particular individual, for example a first responder and/or police officer and/or security guard having an identifier “SAM12” has an elevated body temperature (e.g. “Elevated Body Temp SAM12”) that may be detected using a biometric sensor of one or more sensors 138 and the like.

For example, as depicted the actions 807 include an action 807 for notifying a first responder and/or police and/or security dispatch (e.g. “Notify Dispatch”) such as the dispatch center 131. The actions 807 further includes an action 807 for alerting a particular talkgroup identified by the identifier TG1 and/or Talkgroup #1 (e.g. “Alert TG1”) such as a particular talkgroup of the radios 137 (and/or the radios 153). The actions 807 further includes an action 807 for alerting a particular security team identified by the identifier Security Team 6 (e.g. “Alert Security Team 6”), which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

For example, as also shown in FIG. 9, the trigger “ALPR Delivery Truck” 806 may be added to the workspace 802 a second time from the selection panel 801, as a trigger “ALPR Delivery Truck” 905, and associated with a different action “Alert Security Team 6” 906 (e.g. added as an action 807 from the selection panel 801) by dragging a line 907 between the two, thereby forming a workflow 908. Such an example illustrates that a given trigger 806 may be used more than once to generate a workflow 904, 908, in association with different actions 807. Similarly, a given action 807 may be used more than once in the workspace 802 to form workflows with different triggers 806.

Similarly, as also shown in FIG. 9, the trigger “Loitering NW Staircase” 806 may be added to the workspace 802 from the selection panel 801, as a trigger “Loitering NW Staircase” 909, and associated with action “Alert Security Team 6” 910 (e.g. added as an action 807 from the selection panel 801) by dragging a line 911 between the two, thereby forming a workflow 912. Such an example illustrates that a given action 807 may be used more than once to generate a workflow 908, 912, in association with different triggers 806.

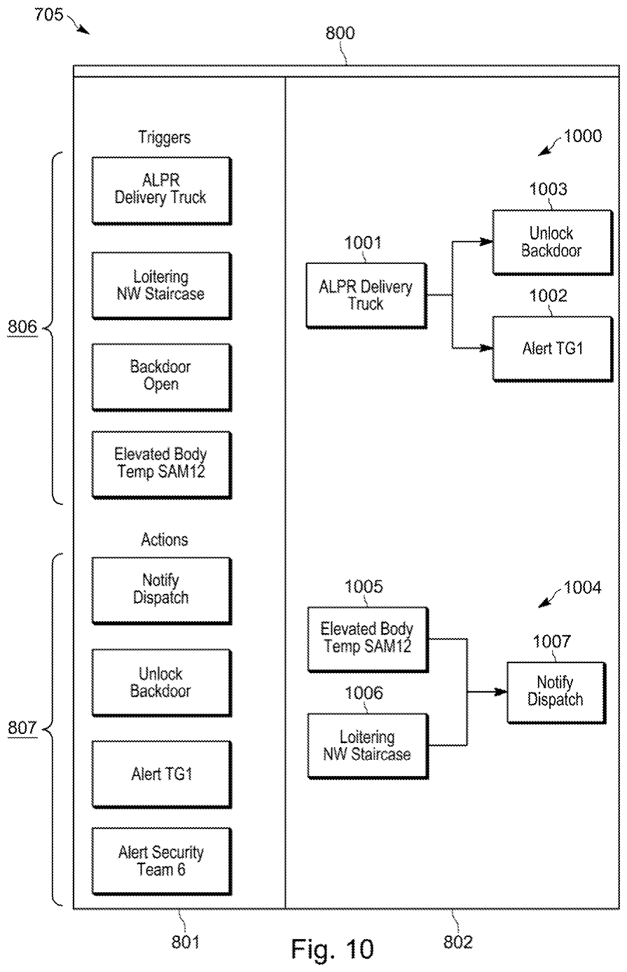

As illustrated in FIG. 10, a single trigger may be associated with multiple actions in a workflow. Thus, in an illustrated workflow 1000, a trigger 1001 of “ALPR Delivery Truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g. above a threshold body temperature”, or when loitering is detected in the NW staircase.

As mentioned above, it may be challenging to communicate to the one or more communication devices the sensor data that lead to the one or more triggers and/or to change and/or control the safety workflows.

In order to address such a problem, the workflow server 102 may be adapted to: monitor execution of a safety workflow, the safety workflow comprising one or more triggers and one or more responsive actions; provide, at a display screen, an indication of the safety workflow and respective visual indications of: a physical sensor that generated sensor data of a trigger of the safety workflow; and a communication device associated with a responsive action to the trigger; detect, via an input device, an interaction with one or more of the respective visual indications to interact with one or more of the physical sensor and the communication device; and based on the interaction, one or more of: retrieve the sensor data; initiate communication with the communication device; and send the sensor data to the communication device.

Hereafter, workflows may be interchangeably referred to as safety workflows as it is understood that workflows as described herein may be used to implement procedures and/or processes related to safety and/or public safety of persons and/or personnel, for example at a school, a hospital, an airport, a sporting event, a stadium, a factory, a warehouse and/or any other suitable location and/or building and the like. Hereafter, the workflow server 102 may be interchangeably referred to as a computing device (e.g. which may be implemented as one or more computing devices, one or more servers, one or more cloud computing devices, and the like). Hereafter, it is understood that any of the sensors 138, cameras 142, IoT devices 163 comprise physical sensors that may generate sensor data that may be provided to the workflow server 102 to determine whether a trigger has occurred.

FIG. 11 depicts a security ecosystem similar to FIG. 1, but instead operating on a plurality of servers receiving workflow instructions from a plurality of workstations operated by different agencies. Specifically, as may be seen, a plurality of workstations 101A, 101B, etc. may be operated by different agencies and/or entities and/or different departments of an agency and/or entity, and the like and may be configured to independently send workflows to workflow server(s) 102 (which are here illustrated as servers 102A and 102B, which are configured to communicate with one another as required). Additional workstations and/or servers may be included. It is to therefore be understood that the present system may be operated on one or more servers 102A and 102B receiving workflow input from one or more workstations 101A and 101B, all keeping within the scope of the present system.

In optional aspects, workstation 101A may be operated by one agency or entity or department (such as a school, hospital, police or fire department, etc., and/or departments thereof) and the other workstation 101B may be operated by another agency or entity or department. For example, one may be operated by a police department with the other operated by school or hospital administrators. In another example, one may be operated by an administration department of a hospital with the other operated by a human resources department of hospital. The present system encompasses any entity or agency or department operating any of the workstations 101. Therefore, in further optional aspects, workstations 101A and 101B may be operated by the same agency or entity or department.

In optional aspects, the workflow server(s) 102 may be adapted to provide a computing system having a network interface (e.g.: network interface 601 in FIG. 6) and a processor (e.g.: processor 603 in FIG. 6) configured to: receive workflows from a plurality of workflow computer systems; identify conflicts in the one or more physical devices that are shared among the workflows; and mitigate identified conflicts by modifying at least one of the workflows to avoid an identified conflict; and providing the at least one workflow as modified back to one or more of workflow computer systems implementing the workflows that caused the conflicts.

In optional aspects, processor 603 may be configured to: receive workflows from a plurality of workflow computer systems (e.g. the workstations 101A, 101B), the workflows comprising respective triggers (806) and respective responsive actions (807) that are executed by one or more physical devices (found in 130, 140, 150 and 160); identify conflicts in the one or more physical devices that are shared among the workflows received from the plurality of workflow computer systems; modify at least one workflow to avoid an identified conflict; and provide the at least one workflow as modified back to one or more of workflow computer systems (e.g. the workstations 101A, 101B) implementing the workflows that caused the conflicts.

In optional aspects, the plurality of workflow computer systems comprises two workflow computer systems (e.g. the workstations 101A, 101B), and the workflow as modified by processor 603 and provided back to both workflow computer systems (e.g. the workstations 101A, 101B).

In optional aspects, processor 603 is further configured to modify the at least one workflow by one or more of: reorganizing workflow steps; generating alternative workflow steps; and activating additional physical devices and assigning one more of existing workflow actions and the alternative workflow actions to the additional physical devices.

In optional aspects, processor 603 is further configured to modify the at least one workflow by one or more of: changing one or more triggers 806 of one or more of the workflows; adding one or more alternative triggers 806 to the one or more of the workflows; changing one or more actions 807 of one or more of the workflows; and adding one or more alternative actions 807 to the one or more of the workflows.

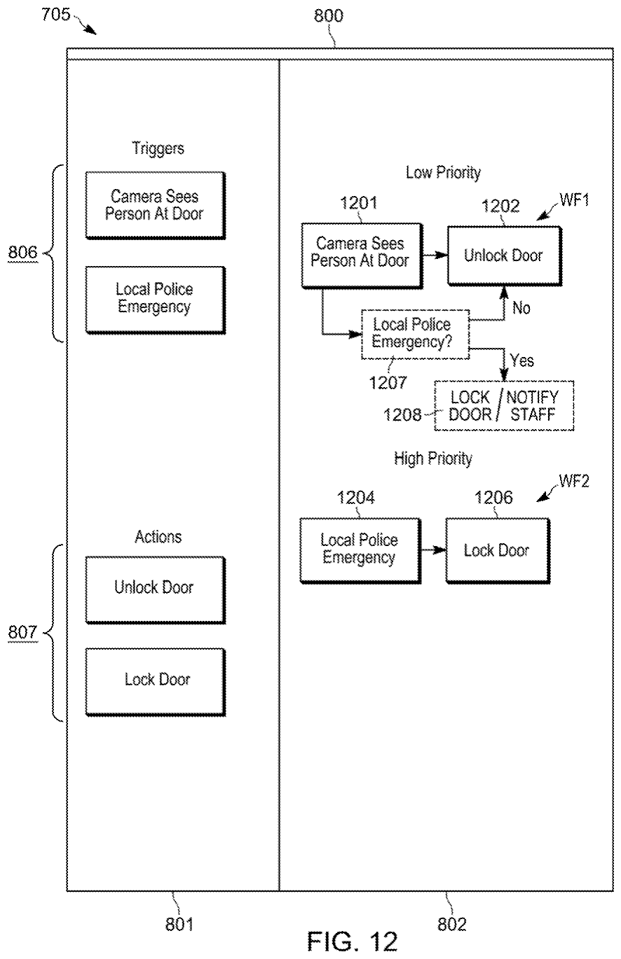

As will be shown in the examples of FIGS. 12 to 14, the present system optionally provides a system for prioritizing a first workflow over a second workflow. Pursuant to the present prioritization system, the system may operate to do one or more of: executing the first workflow and not the second workflow; and executing the first workflow and modifying the second workflow.

In optional aspects, processor 603 is further configured to prioritize the first workflow over the second workflow in accordance with a public safety parameter. Examples of suitable public safety parameters may include incident type or incident severity. For example, as will be shown, police and law enforcement agencies may be afforded priority access to a school's cameras and door locking systems (over school administrators).

In optional aspects, processor 603 is further configured to prioritize the first workflow over the second workflow by: requesting and receiving priority levels for the workflows, and processing the priority levels to determine which of the plurality of workflows comprises the first workflow that is prioritized over the second workflow. This may include, for example, processor 603 requesting workstations 101A and 101B to state or assign the priority levels for their workflows. (This request would be carried out through respective network interfaces 601 and 701).

In other optional aspects, processor 603 is further configured to notify one or more of the plurality of workflow computer systems (e.g. the workstations 101A, 101B) of one or more of: the identified conflict; and the at least one workflow being modified to avoid the identified conflict.

In other optional aspects, processor 603 is further configured to request approval, from one or more of the plurality of workflow computer systems (e.g. the workstations 101A, 101B), for modification of the workflow to avoid the identified conflict.

In further optional aspects, the present system may predict workflow conflicts by reviewing historical performance data that may be analyzed by an analytical engine in processor 603. The analytical engine may include any and all forms of machine learning, artificial intelligence, neural networks, etc. In optional aspects, memory 602 is used to log historic workflow execution data, and processor 603 is further configured to log historic workflow execution data in memory 602. The analytical engine in processor 603 thus predicts conflicts among the physical devices by analyzing the historic workflow execution data stored in memory 602.

For example, historic workflow execution data can include the records of past usages of the various physical devices and/or records of past conflicts of workflows and how such conflicts were resolved, for example by modifying workflows and/or prioritizing workflows and/or by temporarily pausing execution of workflows. For example, this historic workflow execution data can include camera performance and usage rates and records of past conflicts of workflows and how such conflicts were resolved, and may be analyzed over time to determine if the performance of one camera is affected by the operation of various other cameras at the same time and/or to determine how to resolve conflict between workflows. By recording the performance of the various physical devices over time and/or by recording how conflict between workflows were resolved, machine learning algorithms may be trained to determine when conflicts between workflow are occurring and/or how to resolve such conflicts, for example to mitigate conflicts between workflows. Hence, such historic workflow execution data may comprise machine learning training data. As such, conflicts between workflows may be determined by machine learning algorithms even in situations where the workflows do not overtly appear to be in direct conflict.

In other optional aspects, the present system further includes a method of managing workflows received from a plurality of workflow computer systems (e.g. the workstations 101A, 101B), by: receiving, in a multi-workflow computing device (e.g.: processor 603) workflows from a plurality of workflow computer systems (e.g. the workstations 101A, 101B); identifying, in the multi-workflow computing device, conflicts in physical devices that are shared among the workflows; mitigating, in the multi-workflow computing device, the conflicts among the physical devices by modifying at least one workflow to avoid a conflict; and providing the at least one workflow as modified back to one or more of workflow computer systems (e.g. the workstations 101A, 101B) implementing the workflows that caused the conflicts.

This optional method may further include the multi-workflow computing device prioritizing a first workflow received from a first workflow computer system over a second workflow received from a second workflow computer system, and executing only the first workflow. This optional method may also further include notifying both of the workflow computer systems that the first workflow has been prioritized over the second workflow. Moreover, as stated above, the present method may also include processor 603 and memory 602 logging historic workflow execution data, and analyzing the historic workflow execution data to predict conflicts among the physical devices.

In further optional aspects of the methods disclosed herein, the multi-workflow computing device in server(s)102, 102A and 102B mitigating conflicts among the physical devices by: reorganizing workflow steps, generating alternative workflow steps, or activating additional physical devices and assigning workflow steps to the additional physical devices. The multi-workflow computing device may request approval to: modify at least one of the first and second workflows to avoid the conflict, or prioritize the first workflow over the second workflow. In optional aspects, the multi-workflow computing device may even execute both the first and second workflows and detecting the conflict by detecting a drop in workflow performance Next, FIGS. 12 to 14 show specific examples of the present system being used to prioritize a first workflow over a second workflow, as follows.

FIG. 12 depicts the dashboard of FIG. 8 with a first example of two conflicting workflows. The exemplary system of FIG. 12 occurs at a local high school. FIG. 12 has been simplified for ease of illustration to show only one trigger 806, being “Camera Sees Person At Door”. A first workflow (labelled WF1) may have been set up by high school administration department operating one workstation 101A, 101B. Specifically, in accordance with WF1, the associated action 807 will be to “Unlock Door” when the camera's facial recognition system determines that the person standing in front of the camera is a recognized member of the school's teaching or custodial staff. The administration department may set workflow WF1 to be “Camera Sees Person At Door” at 1201, which causes “Unlock Door” at 1202 (similar to the manner described above with respect to FIG. 9). The present system may determine that workflow WF1 is a “Low Priority” workflow in terms of conflict as follows. For example, a local police department operating another workstation 101A, 101B may set up a second workflow (labelled WF2), in which the trigger 806 is declaring a “Local Police Emergency” near the school. The action 807 taken is to “Lock Door” at the school. Specifically, at 1204 the trigger “Local Police Emergency” is associated with the action “Lock Door at 1206. The local police emergency may be determined by the present system to be a “High Priority” workflow.

Accordingly, should a recognized teacher or custodian approach the door of the school at the same time a local police emergency occurs near the school, the door would have been given conflicting instructions. Specifically, the school administrator's workflow is saying “unlock the door” at the same time the police department's workflow is saying “lock the door”. The present system specifically avoids such a conflict by first determining the conflict exists and determines that the police workflow WF2 has a higher priority. As such, police workflow WF2 is carried out and school administrator workflow WF1 is stopped. The setting of these priorities may be carried out by a variety of different approaches, including, but not limited to, the workflow priorities being input into the present system when the workflows are initially set up. Alternatively, the respective workflow priorities may be based upon the identity of the agency originally setting up the workflow. For example, a “Local Police Emergency” 1204 may be set (and/or always set) to have a higher priority than a standard door unlocking procedure. Thus, WF2 having a higher priority than WF1 in FIG. 12 may be due either to the nature of the trigger 1204 being an “Emergency” or due to the workflow WF2 being set up by the police. In optional aspects of the present system, iterative procedures may be used to determine workflow priorities.

Furthermore, the resolution of the conflict between the workflows WF1, WF2 of FIG. 12 may occur using one or more machine learning algorithms and further the resolution of the conflict between the workflows WF1, WF2 of FIG. 12 may be stored in the aforementioned historic workflow execution data to train one or more machine learning algorithms to later resolve conflicts between workflows, for example in a machine learning feedback loop.

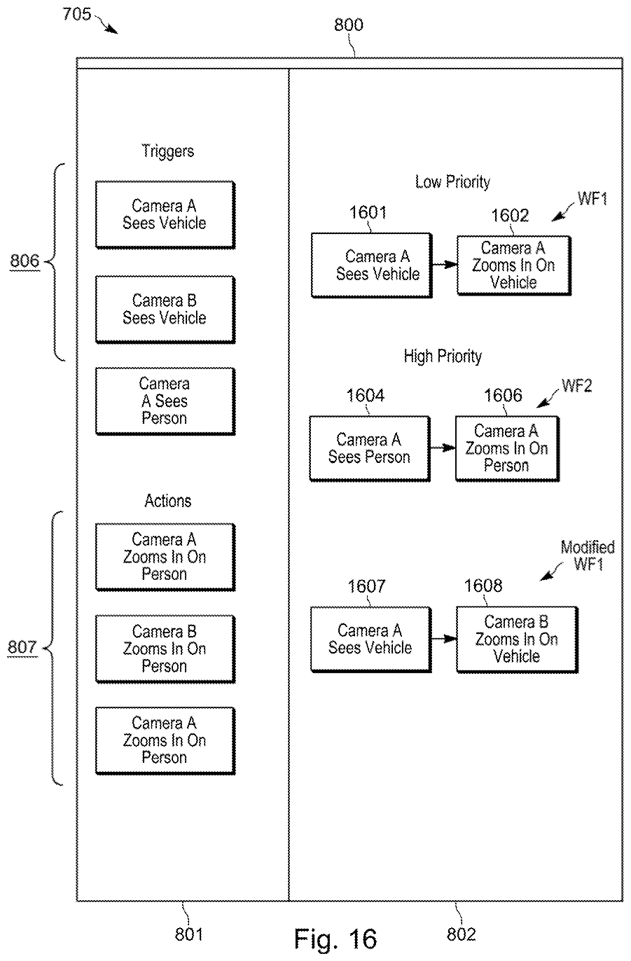

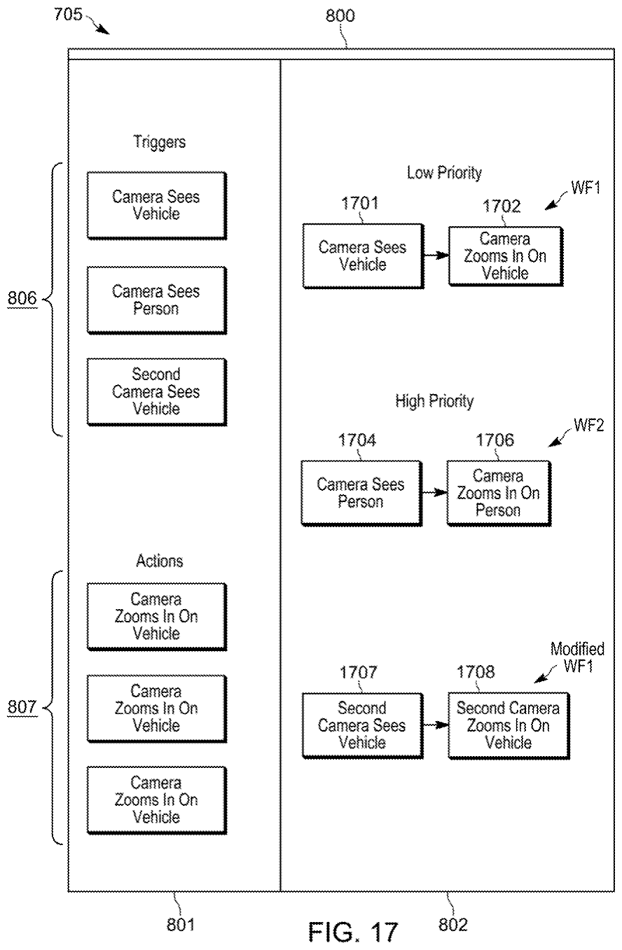

In optional aspects, workflow priorities may be modified based upon the priorities of the respective workflows when workflows conflict (as further illustrated in FIGS. 16 and 17 below). It is to be understood, however, that the workflow priorities may be determined based on the results of communications between the various agencies assigning the workflows. For example, in FIG. 12, the trigger of Local Police Emergency 1204 may send a communication to the high school informing the high school system administrators that their workflow WF1 will automatically be placed on a lower priority than the workflow WF2 set up by the police. In other situations, when conflicting workflows are set up by different agencies, the present system may instigate communication between these agencies to obtain the necessary consent or authorization to have the various agencies workflows increased or decreased in priority with respect to the other agency's workflows. As such, the present system may be configured to determine and/or negotiate permissions between various agencies in terms of assigning (or evaluating, or re-evaluating) the respective priorities of their workflows.

FIG. 12 further shows optional blocks (e.g. triggers and/or action) 1207, 1208 which may occur prior to the action Unlock Door at 1202. The optionality of the blocks 1207, 1208 are indicated by the blocks 1207, 1208 being depicted with dashed lines. In some examples, the blocks 1207, 1208 may be provided in the selection panel 801 (e.g. as triggers 806 and/or actions 807) for placement in the workspace 802. Furthermore, the blocks 1207, 1208 may represent a modification of the workflow WF1, which may occur in response to identifying conflicts in the camera that is shared among the workflows WF1, WF2, and/or the blocks 1207, 1208 may represent actions and/or triggers which be used to identify conflicts and modify the Workflow WF1. In particular, when the “Camera Sees Person At Door” at 1201, the block 1207 may occur, which determines whether a Local Police Emergency has occurred (e.g. the trigger “Local Police Emergency” 1204) such that Workflow WF2 may be conflicting with the Workflow WF1. Put another way, the block 1207 may determine whether there is a conflict between the workflows WF1, WF2. In the case of no police emergency having occurred, (e.g. a “No” decision at the block 1207) the action “Unlock Door” occurs at 1202, and the door will be unlocked. Alternatively, when a Local Police Emergency is detected at block 1207 (e.g. a “Yes” decision at the block 1207, which may determine that the trigger “Local Police Emergency” 1204 has occurred), then the workflow WF2 is modified to “Lock Door” at 1208 and optionally “Notify Staff (e.g. the school staff) as to the existence of the Local Police Emergency (for example by phone call or text, amongst other possibilities). Put another way, the workflow WF1 may be modified to not conflict with the workflow WF2, however it is understood that rather than the action of “Lock Door” occurring at block 1208, the workflow WF1 may be modified to not perform an action related to the door at block 1208 (e.g. so as to prevent multiple lock door signals to be sent to the door, for example one signal at action 1206 and one signal at block 1208), but rather at block 1208 the staff may be notified.

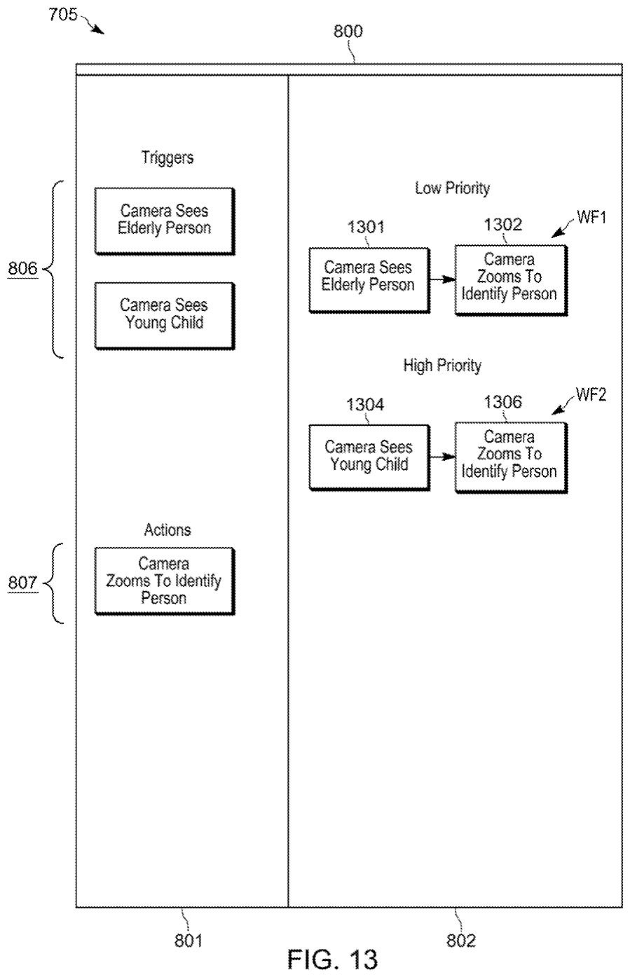

FIG. 13 depicts the dashboard of FIG. 8 with a second example of two conflicting workflows occurring in a hospital. In this example, both workflows WF1 and WF2 have been created, for example by different operators of the workstations 101A, 101B, but both associated with a same hospital administrator department. In this case, the hospital staff are looking for two different people. The first is an elderly patient who is missing. The second person is a young child who is missing. The priority is to find the young person first as this person has been judged by hospital administrators to be more vulnerable. A conflict may occur when the same camera(s) are looking for both of these people at the same time. Specifically, the two triggers 806 are “Camera Sees Elderly Person” and “Camera Sees Young Child”. The action 807 taken in both cases is to zoom in on the person's face to make a positive identification. Thus, workflow WF1 is to “Camera Sees Elderly Person” at 1301 and the “Camera Zooms To Identify The Person” at 1302. Similarly, workflow WF2 is to “Camera Sees Young Child” at 1304 and the “Camera Zooms To Identify The Person” at 1306. The conflict occurs when both an elderly person and a young child are spotted by the camera at the same time. In the absence of the present system, conflicting instructions would have been given to the camera to move in two different directions and zoom in on two different people at the same time. However, in accordance with the present system, the higher priority will be determined to be locating and identifying the child first. Accordingly, the present system will execute workflow WF2 and stop workflow WF1 in this situation. As such, conflicting instructions to the camera are avoided and mitigated. However, workflow WF1 may again be executed after the trigger 1304 of workflow WF2 is no longer occurring (e.g. the camera no longer “sees” the young child). Put another way, the conflict between the workflows WF1, WF2 is resolved by at least temporarily pausing execution of the workflow WF1. (As stated above, the determination as to how the competing priorities are assigned or determined may be done in accordance with the agency or agencies initially setting up the respective workflows. For example, the determination that finding a Young Child is a higher priority action than finding an Elderly person could be determined by the agency (such as, the hospital administrative staff) assigning a higher priority to trigger 1304 than to trigger 1301. Alternatively, the present system may detect an actual or potential conflict and provide a message and/or messages to the agency(ies) that set up workflows WF1, WF2 and request a determination from the agency(ies) as to which of the workflows should have the higher priority. When only one agency has set up multiple workflows, that agency may be requested to prioritize them. However, when different agencies have set up different workflows, the present system may initiate communication to these agencies such that they are aware of the conflict or potential conflict and are to provide a determination as to which workflow has the higher priority, and in what situations. This could involve various agencies agreeing to raise or lower their workflow priorities when working with other agencies and their workflows. Collaboration and authorization regarding determining priorities between the various agencies setting up the workflows is thus encompassed within the scope of the present system.

Furthermore, the resolution of the conflict between the workflows WF1, WF2 of FIG. 13 may occur using one or more machine learning algorithms and further the resolution of the conflict between the workflows WF1, WF2 of FIG. 13 may be stored in the aforementioned historic workflow execution data to train one or more machine learning algorithms to later resolve conflicts between workflows, for example in a machine learning feedback loop. Such machine learning can involve iterative analysis from initially manually set up priorities. For example, the present system may learn that conflicts between police, ambulance or fire agencies (when having their workflows conflicting with that of private businesses or schools) tend to always be resolved with the police, ambulance or fire agencies' workflows being prioritized. As such, the present system may simply detect that a particular workflow has been authored by a police, ambulance or fire agency, and simply assign that workflow a higher priority than a workflow authored by a private businesses or school in the event of a conflict.

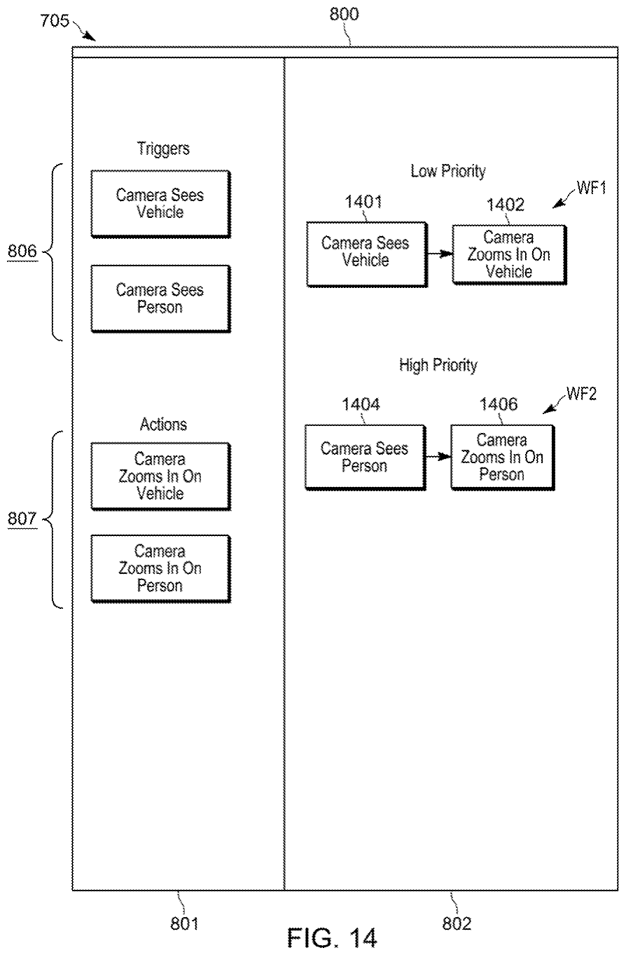

FIG. 14 depicts the dashboard of FIG. 8 with a third example of two potentially conflicting workflows. This example of FIG. 14 occurs at a hospital loading dock. In this example, the loading dock camera is used both to recognize vehicles (by zooming in on their license plates for a positive identification) and to recognize people (by zooming in on their faces for a positive identification). Normally, a vehicle approaches the loading dock first, the camera zooms in on the license plate, the vehicle is recognized, and various actions are taken. Next, a person gets typically out of the vehicle and approaches the camera. At this time, the camera zooms in on the person to use facial recognition to identify the person, and other various actions are taken. Similar to the method described above, workflow WF1 involves the trigger of “S Camera Sees Vehicle” at 1401 and “Camera Zooms In On Vehicle” at 1402. Workflow WF2 involves “Camera Sees Vehicle” at 1404 and “Zooming In On Person” at 1406.

However, in a particular example, a vehicle may approach the loading dock at the same time that a person also comes walking up to the loading dock. A potential conflict occurs when the camera could be given conflicting instructions to zoom in on the vehicle and the person at the same time. However, in accordance with the present system, hospital administrators may prioritize identifying the person over the vehicle such that workflow WF2 is prioritized and is carried out and the workflow WF1 is not carried out. However, workflow WF1 may again be executed after the trigger 1404 of workflow WF2 is no longer occurring (e.g. the camera no longer “sees” the person). Put another way, the conflict between the workflows WF1, WF2 is resolved by at least temporarily pausing execution of the workflow WF1.

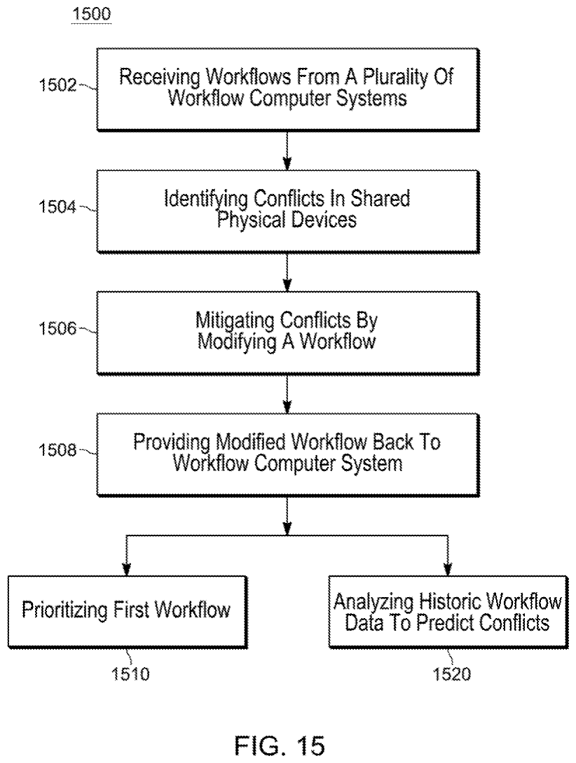

Furthermore, the resolution of the conflict between the workflows WF1, WF2 of FIG. 14 may occur using one or more machine learning algorithms and further the resolution of the conflict between the workflows WF1, WF2 of FIG. 15 may be stored in the aforementioned historic workflow execution data to train one or more machine learning algorithms to later resolve conflicts between workflows, for example in a machine learning feedback loop.

FIG. 15 depicts an exemplary flowchart of an optional method of operating the present security ecosystem. The method of FIG. 15 may correspond to machine readable instructions that are executed on workflow server(s) 102, and specifically by processor 603. In the illustrated example, the instructions are represented by blocks of FIG. 15 and may be stored at storage component 602. The method 1500 need not be performed in the exact sequence as shown and likewise various blocks may be performed in parallel rather than in sequence. Accordingly, the elements of method 1500 are referred to herein as “blocks” rather than “steps”.

In accordance with method 1500, workflows are managed by a multi-workflow computing system receiving workflows from a plurality of workflow computer systems at a block1502; identifying conflicts in physical devices that are shared among the workflows at a block 1504; mitigating the conflicts among the physical devices by modifying at least one workflow to avoid a conflict at a block 1506; and providing the at least one workflow as modified back to one or more of workflow computer systems implementing the workflows that caused the conflicts at a block 1508. Optionally, the present method 1500 may include prioritizing a first workflow over a second workflow at a block 1510, for example as described above with respect to FIG. 12, FIG. 13 and FIG. 14. Optionally, the present method 1500 may analyzing the historic workflow execution data to predict conflicts among the physical devices at a block 1520; while the blocks 1510, 1520 are depicted as occurring after the previous blocks of the method 1500, the blocks 1510, 1520 may occur in conjunction with, and/or before and/or after. any block of the method 1500.

FIG. 16 depicts the dashboard of FIG. 8 showing a lower priority workflow being modified when it conflicts with a higher priority workflow. As such, the example of FIG. 16 may provide an example of at least the block 1506 of the method 1500. Specifically, FIG. 16 shows a fourth example of two potentially conflicting workflows. This example also occurs at a vehicle loading dock similar to FIG. 14. However, in the example of FIG. 16, two cameras (Camera A and Camera B) are involved. Cameras A and B may have overlapping fields of view, but Camera A may be generally preferred for imaging people or vehicles (for example, Camera A may be closer to the door where a delivery person would stand). As seen in FIG. 16, workflow WF1 involves the trigger of “Camera A Seeing Vehicle” at 1601 and the action of “Camera A Zooms In On Vehicle” at 1602. Workflow WF2 involves the trigger of “Camera A Sees Person” at 1604 and the action of “Camera A Zooms In On Person” at 1606. In the event that Camera A sees both a person and a vehicle at the same time, the higher priority workflow WF2 will be executed. Importantly, however, the lower priority workflow WF1 will be modified such that when Camera A Sees Vehicle at 1607, Camera B will now be called into use and the action taken will instead be “Camera B Zooms In On Vehicle” at 1608.

FIG. 17 depicts the dashboard of FIG. 8 showing a second device being activated to assist a first device in the event of a workflow conflict. Specifically, As such, the example of FIG. 17 may provide an example of at least the block 1506 of the method 1500. Specifically, FIG. 17 shows a fifth example of two potentially conflicting workflows. This example also occurs at a vehicle loading dock similar to FIG. 14. However, in the example of FIG. 17, two cameras are involved but only one is initially active. As seen in FIG. 17, workflow WF1 involves the trigger of “Camera Seeing Vehicle” at 1701 and the action of “Camera Zooms In On Vehicle” at 1702. Workflow WF2 involves the trigger of “Camera Sees Person” at 1704 and the action of “Camera Zooms In On Person” at 1706. In the event that the camera sees both a person and a vehicle at the same time, the higher priority workflow WF2 will be executed. Importantly, however, the lower priority workflow WF1 may be modified to include a trigger 1707 of “Second Camera Sees Vehicle” and an action 1708 of “Second Camera Zooms In On Vehicle”. As depicted, both the trigger 1707 of “Second Camera Sees Vehicle” and the action 1708 of “Second Camera Zooms In On Vehicle” are respectively included in the triggers 806 and actions 807. As such, the first camera images the person according to the second workflow, while the second camera images the vehicle according to the modified first workflow. It is understood that the modified first workflow may include activating the second camera.

In various aspects of the system, a workflow conflict notification may be provided, for example at the workspace 802, and may come from one of the devices that senses that a workflow conflict has occurred. For example, in the above scenarios of FIGS. 16 and 17, any one of the cameras in FIG. 16 or 17 may determine that a conflict has occurred and/or such a conflict may be determined by one or more of the workflow servers 102, and provide the conflict notification to a workstation 101. It is to be understood, however, that the present system encompasses systems and methods in which any of the potentially conflicting devices described herein can send conflict notifications to a workflow server 102 such that these workflow notifications can be used in making workflow conflict decisions and modifications to workflows.

Furthermore, the resolution of the conflict between the workflows WF1, WF2 of FIGS. 16 and 17 may occur using one or more machine learning algorithms and further the resolution of the conflict between the workflows WF1, WF2 of FIGS. 16 and 17 may be stored in the aforementioned historic workflow execution data to train one or more machine learning algorithms to later resolve conflicts between workflows, for example in a machine learning feedback loop.

Indeed, it is understood that one or more machine learning algorithms may be placed into a training mode to train the one or more machine learning algorithms to one or more of determine conflicts between workflows and resolve conflicts between workflows. Alternatively, and/or in addition, such training may occur in a machine learning feedback loop.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, implement electronic workflows, and the like such as determining whether cameras should be zoomed in or out to recognize specific individuals and/or vehicles in real time, or to lock or unlock doors depending upon the identity of the individuals approaching them (especially when the individuals are recognized electronically through RFID sensors and the like in real time). Moreover, a human mind could not discriminate between workflow commands that are being send by different entities and agencies at the same time in a manner that the workflow commands could be prioritized or modified in real time.

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein may have several different meanings depending on the context in which these terms are used. For example, the terms coupled, coupling, or connected can have a mechanical or electrical connotation. For example, as used herein, the terms coupled, coupling, or connected may indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computing device comprising:
a network interface; and
a processor configured to:
receive workflows from a plurality of workflow computer systems, the workflows comprising: respective triggers and respective responsive actions that are executed by one or more physical devices;
identify conflicts in the one or more physical devices that are shared among the workflows received from the plurality of workflow computer systems;
modify at least one workflow to avoid an identified conflict; and
provide the at least one workflow as modified back to one or more of workflow computer systems implementing the workflows that caused the conflicts.

2. The computing device of claim 1, wherein the plurality of workflow computer systems comprises two workflow computer systems, and the workflow as modified is provided to both workflow computer systems.

3. The computing device of claim 1, wherein the processor is further configured to modify the at least one workflow by one or more of:
reorganizing workflow steps;
generating alternative workflow steps; and
activating additional physical devices and assigning one more of existing workflow actions and alternative workflow actions to the additional physical devices.

4. The computing device of claim 1, wherein the processor is further configured to modify the at least one workflow by one or more of:
changing one or more triggers of one or more of the workflows;
adding one or more alternative triggers to the one or more of the workflows;
changing one or more actions of one or more of the workflows; and
adding one or more alternative action to the one or more of the workflows.

5. The computing device of claim 1, wherein the processor is further configured to modify at least one workflow to avoid the identified conflict by:
prioritizing a first workflow received from a first workflow computer system over a second workflow received from a second workflow computer system; and
one or more of:
executing the first workflow and not the second workflow; and
executing the first workflow and modifying the second workflow.

6. The computing device of claim 5, wherein the processor is further configured to prioritize the first workflow over the second workflow in accordance with a public safety parameter.

7. The computing device of claim 6, wherein the public safety parameter is one of incident type or incident severity.

8. The computing device of claim 5, wherein the processor is further configured to prioritize the first workflow over the second workflow by:
requesting and receiving priority levels for the workflows, and
processing the priority levels to determine which of the plurality of workflows comprises the first workflow that is prioritized over the second workflow.

9. The computing device of claim 8, wherein the priority levels are received via the network interface by two or more of the plurality of workflow computer systems.

10. The computing device of claim 1, wherein the processor is further configured to notify one or more of the plurality of workflow computer systems of one or more of:
the identified conflict; and
the at least one workflow being modified to avoid the identified conflict.

11. The computing device of claim 1, wherein the processor is further configured to request approval, from one or more of the plurality of workflow computer systems, for modification of the workflow to avoid the identified conflict.

12. The computing device of claim 1, further comprising a memory for logging historic workflow execution data, and wherein the processor is further configured to log historic workflow execution data in the memory.

13. The computing device of claim 12, wherein the processor is further configured to:
predict conflicts among the physical devices by analyzing the historic workflow execution data stored in the memory.

14. A method of managing workflows received from a plurality of workflow computer systems, comprising:
receiving, in a multi-workflow computing device, workflows from a plurality of workflow computer systems;
identifying, in the multi-workflow computing device, conflicts in physical devices that are shared among the workflows;
mitigating, in the multi-workflow computing device, the conflicts among the physical devices by modifying at least one workflow to avoid a conflict; and
providing the at least one workflow as modified back to one or more of workflow computer systems implementing the workflows that caused the conflicts.

15. The method of claim 14, further comprising:
prioritizing a first workflow received from a first workflow computer system over a second workflow received from a second workflow computer system; and
executing only the first workflow.

16. The method of claim 15, wherein the first workflow is prioritized over the second workflow in accordance with a public safety parameter.

17. The method of claim 14, wherein the plurality of workflow computer systems comprises two workflow computer systems, and the method further comprises:
notifying both of the workflow computer systems that the first workflow has been prioritized over the second workflow.

18. The method of claim 14, further comprising:
logging historic workflow execution data; and
analyzing the historic workflow execution data to predict conflicts among the physical devices.

19. The method of claim 14, further comprising mitigating conflicts among the physical devices by one or more of:
reorganizing workflow steps;
generating alternative workflow steps; and
activating additional physical devices and assigning workflow steps to the additional physical devices.

20. The method of claim 14, further comprising requesting approval to one or more of:
modify at least one of the first and second workflows to avoid the conflict; and
prioritize the first workflow over the second workflow.
